(19) United States
(12) Patent Application Publication
(10) Pub. No.: US 2025/0338302 A1
(43) Pub. Date: Oct. 30, 2025

(54) TRAFFIC LOAD MANAGEMENT

(71) Applicants: AT&T Intellectual Property I, L.P., Atlanta, GA (US); AT&T Mobility II LLC, Atlanta, GA (US)

(72) Inventors: Kemal Kara, San Francisco, CA (US); Yusef Shaqalle, Minneapolis, MN (US); Slawomir Mikolaj Stawiarski, Carpentersville, IL (US); Shomik Pathak, Richardson, TX (US); Weiyi Zhang, Edison, NJ (US); Melanie Albertin, Plano, TX (US); Anitha Kamma, Plano, TX (US); Timothy Geraghty, Florham Park, NJ (US); He Yan, Berkeley Heights, NJ (US); Shahzad Salahuddin, Plano, TX (US)

(73) Assignees: AT&T Intelletual Property I, L.P., Atlanta, GA (US); AT&T Mobility II LLC, Atlanta, GA (US)

(21) Appl. No.: 18/650,991

(22) Filed: Apr. 30, 2024

(51) Int. Cl. H04W 72/52; H04B 17/318; H04W 36/22; H04W 72/0453; H04W 72/232

(52) U.S. Cl. CPC H04W 72/52; H04B 17/328; H04W 36/22; H04W 72/0453; H04W 72/232

(57) ABSTRACT

Aspects of the subject disclosure may include, for example, determining that a first network node device satisfies an overload threshold; identifying a second network node device that satisfies an availability threshold and that is initiating incoming handovers of second network communication devices, assigning one or more first values to one or more respective first relation parameters, each first value being associated with control of the incoming handovers of the second network communication devices; selecting a third network node device that satisfies an availability threshold, the third network node device being selected to receive outgoing handovers from the first network node device; and assigning one or more second values to one or more respective second relation parameters, each second value being associated with control of the outgoing handovers to the third network node device, wherein the one or more second values are assigned independently of the one or more first values. Other embodiments are disclosed.

### CROSS REFERENCE TO RELATED APPLICATION(S)

This application is related to U.S. Pat. No. 11,653,258, issued on May 16, 2023. All sections of the aforementioned application(s) and/or patent(s) are incorporated herein by reference in their entirety.

This application is also related to U.S. Pat. No. 11,032,735, issued on Jun. 8, 2021. All sections of the aforementioned application(s) and/or patent(s) are incorporated herein by reference in their entirety.

### FIELD OF THE DISCLOSURE

The subject disclosure relates to traffic load management.

### BACKGROUND

In certain conventional wireless communication systems (e.g., in a Long-Term Evolution (LTE) system), a plurality of user equipment (UE) devices are distributed across network and cell carriers. When a given UE device establishes a connection to a cell, the UE device consumes cell resources. The resources (in this case-PDCCH CCE (PDCCH: Physical_Downlink_Control_Channel, CCE: Control_Channel_Elements)) are limited and can be exhausted if a large number of UE devices attempt to connect to the cell. The resource exhaustion typically results in UE connection establishment rejection (cell access failure) and throughput degradation for the UE devices already connected to a congested cell (and, as a consequence, very poor experience for the cell phone users). Such congestion and high utilization of resources in a congested cell typically negatively affect all types of devices and users-regular customers, high-priority customers, First Net customers, and others.

In certain situations, cell overload conditions in the network are observed on a non-trivial percentage of sites every day. The overload can occur, for example, on the same sites every day due to regular traffic load. In addition, overload conditions are frequently observed during massive events such as parades, games, concerts, fairs etc., or during sudden events such as a tornado, flooding, road traffic jams, and accidents. During these events, when cells are overloaded, the customers do not receive good network access or service (and First Net users are at high risk of disconnecting from the network due to congestion). The aforementioned network troubles typically cause churn and customer loss, costing carriers a significant amount of money each year. In addition, in an attempt to reduce congestion of observed sites, additional hardware is sometimes installed to increase capacity at the sites (wherein such installation of additional hardware drives up capital spending).

Conventional traffic management and load management solutions provided by network infrastructure vendors are typically not completely effective and sometimes do not resolve overload conditions on the cells as expected. Further, certain conventional traffic management solutions are not coordinated and perform contradicting decisions (which often exacerbate further overloaded conditions at the problem cells) or are coordinated but nevertheless fail to optimally address the issues.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communication network in accordance with various aspects described herein.

FIG. 2A is a block diagram illustrating an example, non-limiting embodiment of a system (which can function fully or partially within the communication network of FIG. 1) in accordance with various aspects described herein.

FIG. 2B is a block diagram illustrating an example, non-limiting embodiment of a system (which can function fully or partially within the communication network of FIG. 1) in accordance with various aspects described herein.

FIG. 2C is a block diagram illustrating an example, non-limiting embodiment of a system (which can function fully or partially within the communication network of FIG. 1) in accordance with various aspects described herein.

FIG. 2D is a diagram illustrating an example, non-limiting embodiment of data collection related to a traffic load management process (which can function fully or partially within the communication network of FIG. 1) in accordance with various aspects described herein.

FIG. 2E is a diagram illustrating an example, non-limiting embodiment of a data chart related to a traffic load management process (which can function fully or partially within the communication network of FIG. 1) in accordance with various aspects described herein.

FIG. 2F depicts an illustrative embodiment of a method in accordance with various aspects described herein.

FIG. 2G depicts an illustrative embodiment of a method in accordance with various aspects described herein.

FIG. 2H depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for traffic load management. Other embodiments are described in the subject disclosure.

One or more aspects of the subject disclosure include traffic load management for one or more wireless communication networks (e.g., one or more 4th generation (4G) cellular networks, one or more 5th generation (5G) cellular networks, one or more subsequent generation cellular networks, or any combination thereof).

One or more aspects of the subject disclosure include traffic load management for a particular wireless communications access point (e.g., an eNodeB, a gNodeB) that is experiencing congestion (e.g., too many connected mobile devices, resource utilization that is too high, latency that is too high, throughput that is too low, or any combination thereof). In one embodiment, first parameter(s) can be set for user devices that are incoming to the congested access point (or node) from an incoming access point (or node) and second parameter(s) can be set for user devices that are outgoing from the congested access point (or node) to an outgoing access point (or node). In one embodiment, value(s) of the first parameter(s) can be set independently of value(s) of the second parameters.

One or more aspects of the subject disclosure include a mechanism for adjusting selected Cell Relational Parameters (e.g., cell individual offset (CIO) padding for Connected mode and/or qOffset padding for Idle mode) from a source cell to a target cell (and reverting the parameters back once the congestion is over).

One or more aspects of the subject disclosure include a mechanism for changing cell level Idle Mode parameters to eliminate (that is, transfer away) a number of cell edge users without identifying the target cells. Such embodiments can alleviate the cell's congestion (and then the users can be reverted back once the congestion is over).

One or more aspects of the subject disclosure include a mechanism for changing Cell Relation level parameters from a Congested Cell to neighboring non-congested cells (to push the traffic from the Congested Cell to the neighboring cells) and changing Cell Relation level parameters from Neighboring non-congested cells to a Congested Cell to slow down the traffic from the adjacent (neighboring) cells to the Congested Cell The parameters changed by the above-mentioned two scenarios can use different values (e.g., to make sure parameter values are changed more from neighboring cells to the congested cell). Once congestion is over, parameter values can be reverted to the original values.

One or more aspects of the subject disclosure include a mechanism for deactivating a Congested Cell (that would otherwise be used in Carrier Aggregation) to push extra users away from the Congested Cell. This can increase the Congested Cell's traffic load (the parameters can be reverted once the congestion is over).

One or more aspects of the subject disclosure include a mechanism for adjusting the amount of traffic shift by using the signal level distribution for the Idle Mode cell level parameters (and reverting the parameters once the congestion is over).

One or more aspects of the subject disclosure include a mechanism for triggering on different trigger conditions for coverage restrictions (thus adding flexibility so that a user (e.g., person working for a network operator) can decide when to limit cell coverage). For example, a user can set the throughput and resource utilization for coverage restriction at a different level than the overload condition triggers (wherein, for example, only cells with exceptionally low throughput will see coverage restriction—making the solution more targeted).

One or more aspects of the subject disclosure include a device comprising: a processing system including a processor; and a memory that stores executable instructions that, when executed by the processing system, facilitate performance of operations, the operations comprising: determining that a first network node device satisfies an overload threshold related to first network communication devices connected to the first network node device, resulting in a first determination; identifying a second network node device that satisfies an availability threshold and that is initiating incoming handovers of second network communication devices, different than the first network communication devices, to the first network node device; assigning one or more first values to one or more respective first relation parameters, each first value being associated with control of the incoming handovers of the second network communication devices; selecting a third network node device that satisfies an availability threshold, the third network node device being selected to receive outgoing handovers from the first network node device; assigning one or more second values to one or more respective second relation parameters, each second value being associated with control of the outgoing handovers to the third network node device, wherein the one or more second values are assigned independently of the one or more first values; facilitating use of the one or more first values to control the incoming handovers of the second network communication devices; and facilitating use of the one or more second values to control the outgoing handovers from the first network node device.

One or more aspects of the subject disclosure include a non-transitory machine-readable medium comprising executable instructions that, when executed by a processing system including a processor, facilitate performance of operations, the operations comprising: obtaining first data indicative of an existing cutoff value of a communication quality, wherein the first data is a parameter that is currently set in a network; obtaining second data indicative of a plurality of current communication qualities, wherein each of the plurality of current communication qualities comprises Reference Signal Received Power (RSRP), Reference Signal Received Quality (RSRQ), or any combination thereof; segmenting the second data such that each of the current communication qualities is placed into one of a plurality of segments, wherein each of the plurality of segments has a corresponding numerical count, resulting in a segmented data set; selecting a percentage of a total number of the current communication qualities to be subject to congestion control, wherein the selecting results in a selected percentage; determining, based upon the segmented data set and the selected percentage, a modified cutoff value of the communication quality, wherein the modified cutoff value is a modification of the parameter that had been set in the network; and facilitating the congestion control based upon the modified cutoff value of the communication quality.

One or more aspects of the subject disclosure include a method, comprising: determining, by a processing system including a processor, whether a first carrier (or cell) within a sector of a communications network is cooperating with a second carrier (or cell) of the same sector in a carrier aggregation process that facilitates communications with a plurality of end user mobile devices, resulting in a first determination; determining, by the processing system, that the first carrier (or cell) satisfies an overload threshold, resulting in a second determination; and responsive to the first determination being that the first carrier (or cell) is cooperating with the second carrier (or cell) in the carrier aggregation process and to the second determination being that the first carrier (or cell) satisfies the overload threshold, causing, by the processing system, the first carrier (or cell) to terminate the carrier aggregation process.

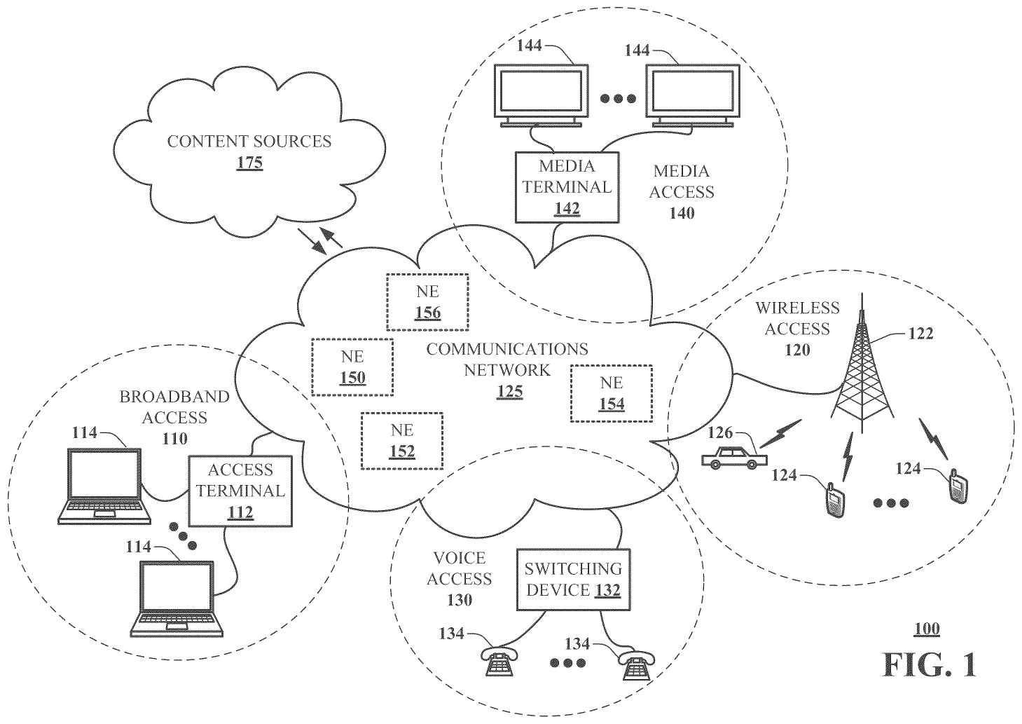

Referring now to FIG. 1, a block diagram is shown illustrating an example, non-limiting embodiment of a system 100 in accordance with various aspects described herein. For example, system 100 can facilitate in whole or in part traffic load management for one or more wireless communication networks (e.g., traffic load management for an access point (or node) that is experiencing traffic congestion). In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

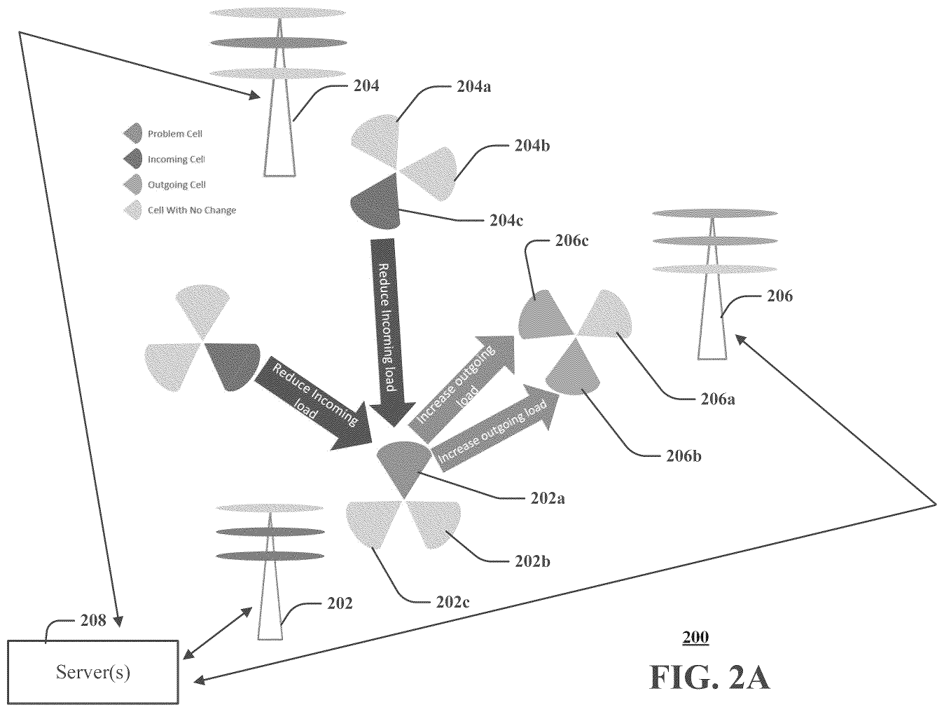

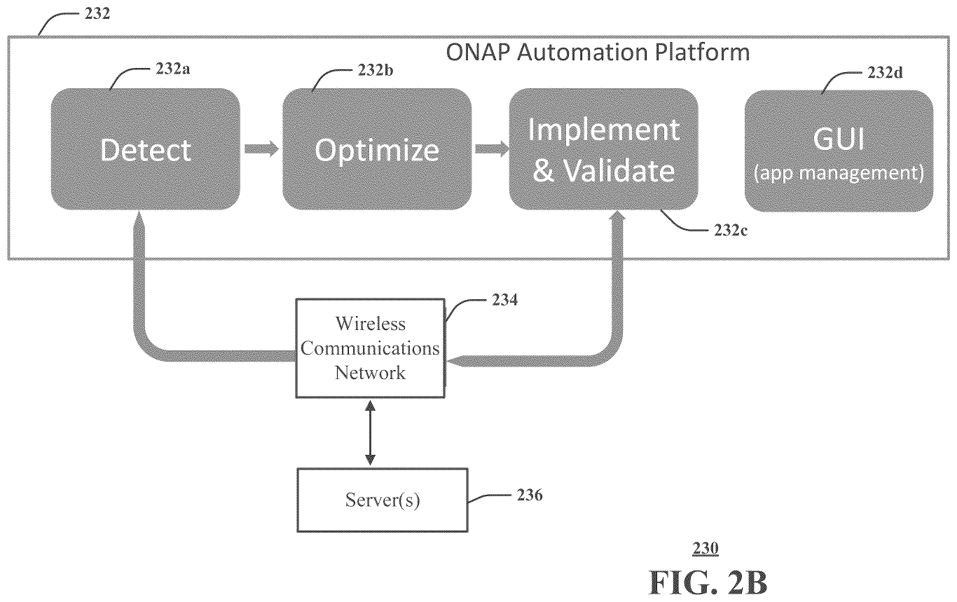

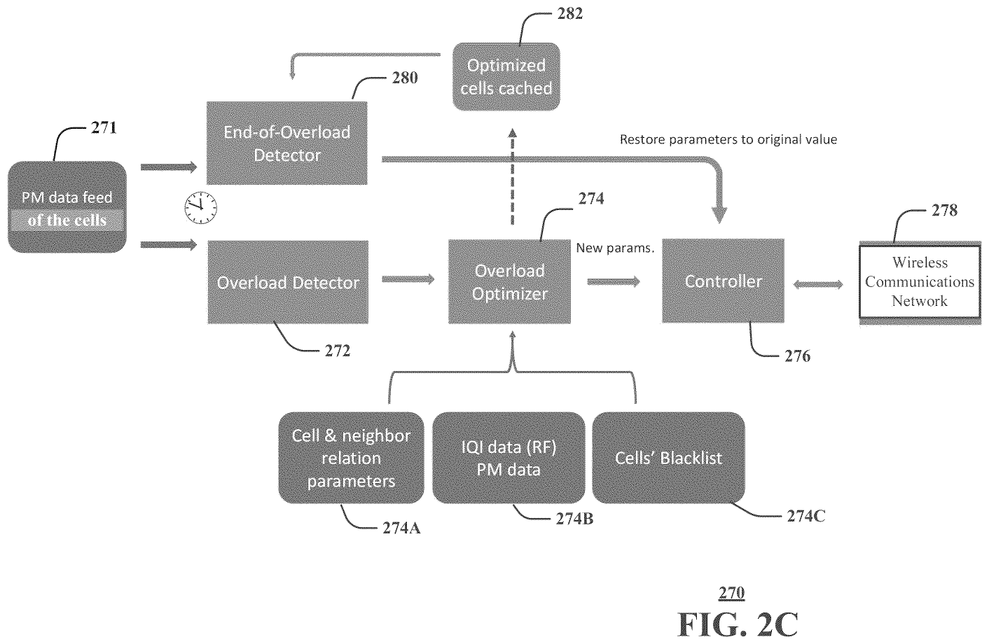

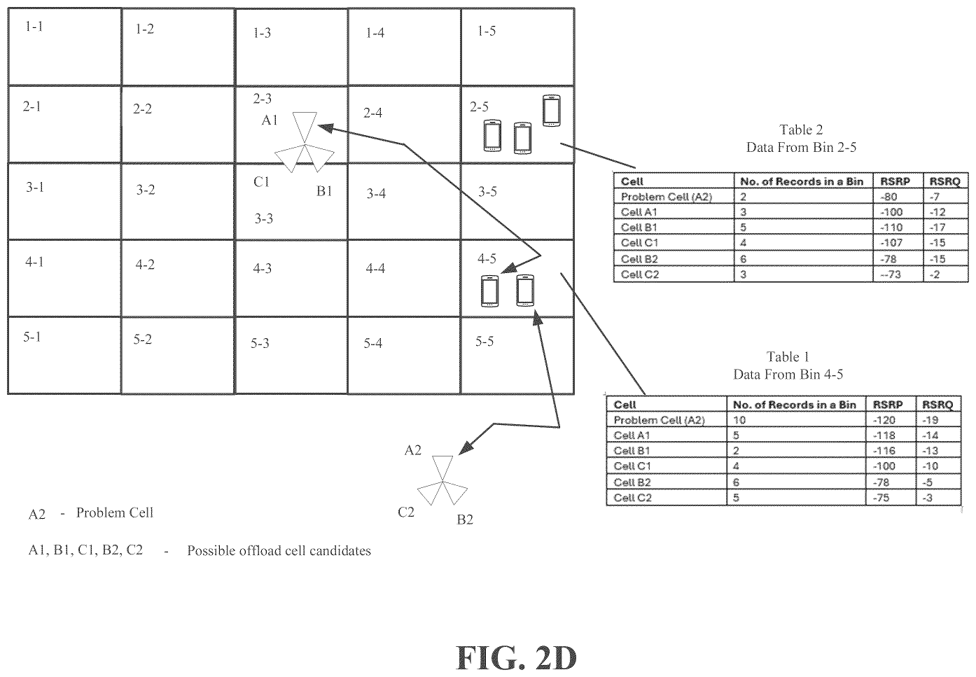

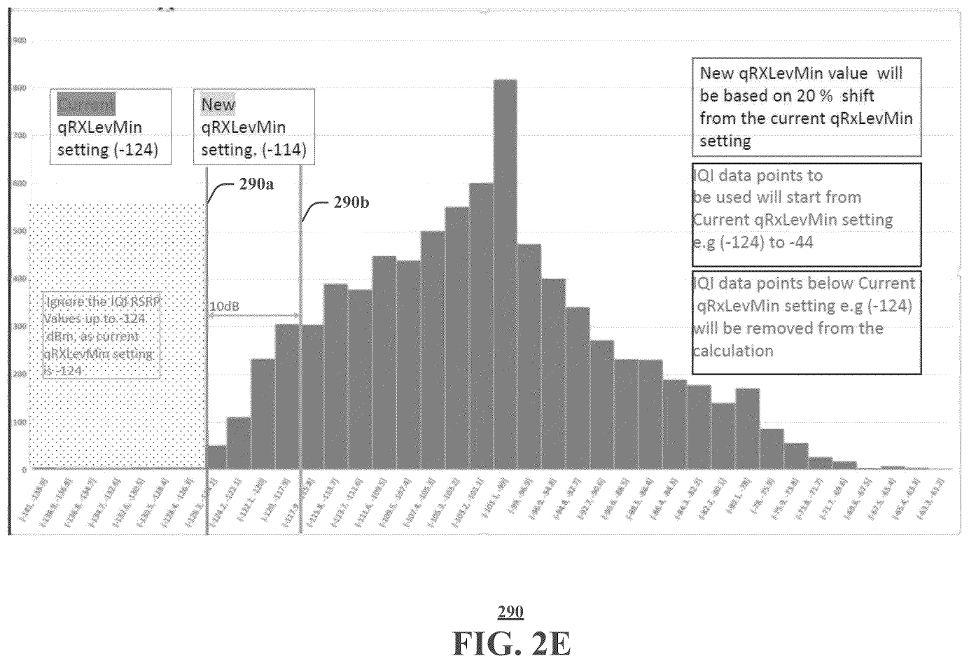

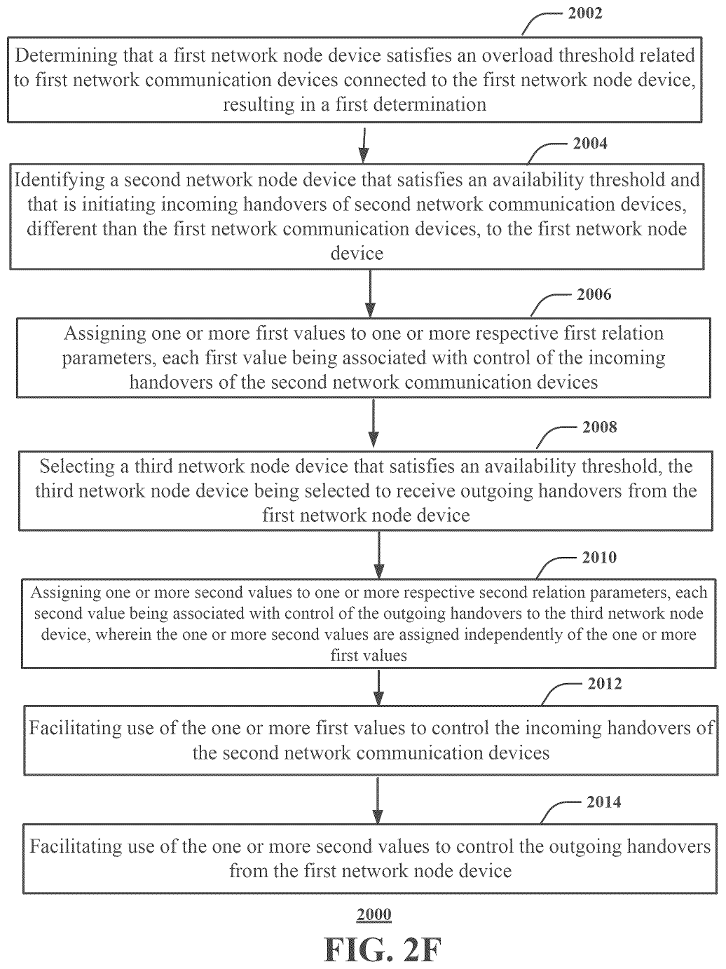

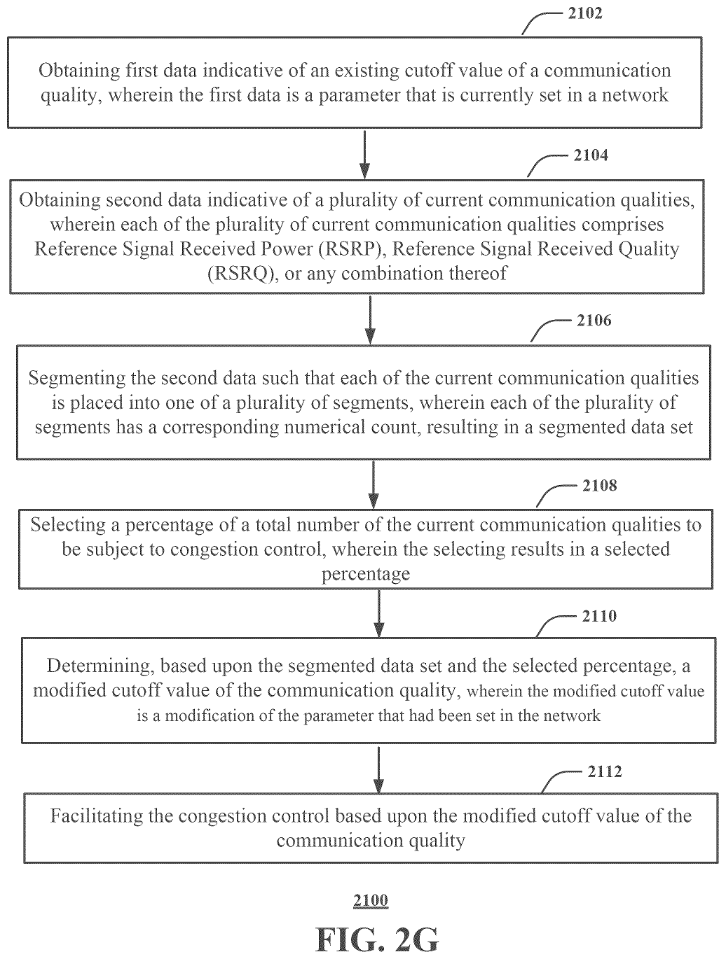

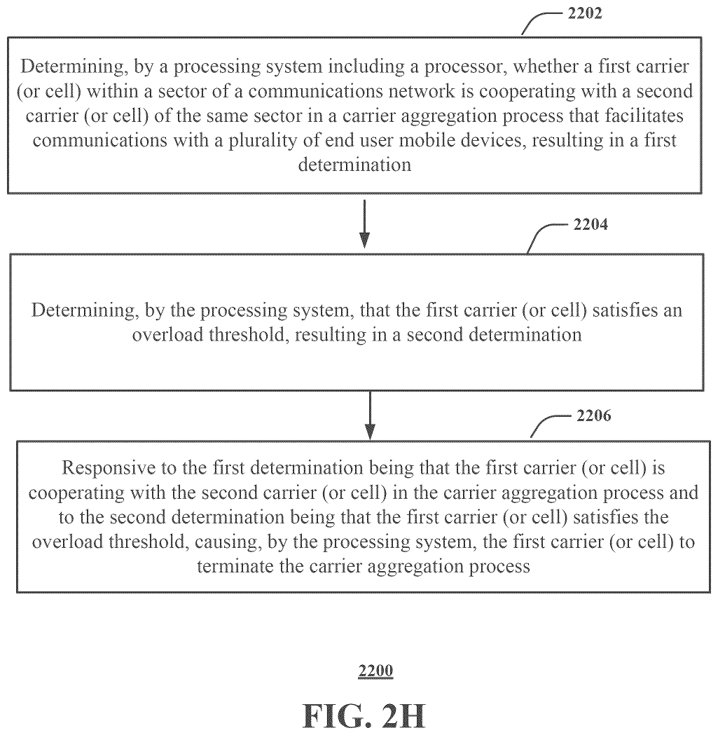

Referring now to FIG. 2A, this is a block diagram illustrating an example, non-limiting embodiment of a system 200 (which can function fully or partially within the communication network of FIG. 1) in accordance with various aspects described herein. As seen in this figure, embodiments related to traffic offload mode of operation and optimization are depicted. The system 200 includes a plurality of communication system nodes (in this example, node 202 (including three faces—202a, 202b, 202c), node 204 (including three faces—204a, 204b, 204c), and node 206 (including three faces—206a, 206b, 206c)). Server(s) 208 are in bi-directional communication with each of the nodes. Server(s) 208 can include hardware, firmware, and/or software. Server(s) 208 are configured to implement various traffic load management functions as described herein (e.g., during congestion, steer traffic to neighboring cells with spare capacity in order to reduce overload, and improve throughput speed). Various embodiments can provide for: (a) 24/7 overload detection monitoring (e.g., acute and chronic); (b) Immediate optimization and implementation (e.g., real time “what-if” analysis to find best parameters configuration; (c) Revert to original configuration when congestion event is over; (d) Reporting and alert notifications; (e) any combination thereof. In various embodiments, traffic offloading can be on per neighbor relation (e.g., intra or inter site neighbor relations/frequencies).

Referring now to FIG. 2B, this is a block diagram illustrating an example, non-limiting embodiment of a system 230 (which can function fully or partially within the communication network of FIG. 1) in accordance with various aspects described herein. As seen in this figure, embodiments related to traffic offload mode of operation and optimization are depicted. The system 230 includes an ONAP Automation Platform 232 (which implements various functions, including: Detect 232a, Optimize 232b, Implement & Validate 232c, and GUI (app management) 232d). The system 230 further includes a Wireless Communications Network 234 and Server(s) 236. Server(s) 236 are configured to implement various traffic load management functions as described herein.

Referring now to FIG. 2C, this is a block diagram illustrating an example, non-limiting embodiment of a system 270 (which can function fully or partially within the communication network of FIG. 1) in accordance with various aspects described herein. As seen in this figure, a number of high-level process steps to set parameters and to restore parameters are shown. The system 270 includes an Overload Detector 272, an Overload Optimizer 274, a Controller 276, a Wireless Communications Network 278, and an End-of-Overload Detector 280. In operation, the Overload Detector 272 receives a performance monitoring (PM) data feed of the cells (congestion information such as throughput and PDCCH CCE Utilization data) (see element 271). Based upon the received PM data the Overload Detector 272 makes a determination that a cell is in a congested condition. Based upon the cell being in the congested condition, the Overload Detector 272 communicates with the Overload Optimizer 274 to cause the Overload Optimizer 274 to send new (or updated) parameter values to the controller 276. In various embodiments, the PM data feed of the cells can be supplied to the Overload Detector 272 essentially continuously or periodically (e.g., every x number of minutes, every x number of seconds). In various embodiments, the Overload Detector 272 can decide that congestion exists based upon a Control Channel Element (CCE) of a Physical Downlink Control Channel (PDCCH) that is too high, a latency that is too high, a throughput that is too low, a signal quality that is too low, a power level that is too low, or any combination thereof. In various embodiments, the Overload Detector 272 can decide that congestion exists based upon input information including Cell & neighbor relation parameters. In various embodiments, the Overload Optimizer 274 can output information (that can be cached) related to Optimized Cells (see element 282). In various embodiments, the parameters 274A, data 274B, and blacklist 274C can be used to decide the new parameter values to be implemented to fix the congestion.

Still referring to FIG. 2C, it is seen that in operation, the End-of-Overload Detector 280 receives performance monitoring (PM) data feed of the cells (see element 271) as well as the information regarding Optimized Cells (see element 282). Based upon the received PM data and the information regarding Optimized Cells, the End-of-Overload Detector 280 makes a determination that a cell is no longer in a congested condition. Based upon the cell no longer being in the congested condition, the End-of-Overload Detector 280 communicates with the controller 276 to restore parameter values (to their original or previous values). In various embodiments, the PM data feed of the cells can be supplied to the End-of-Overload Detector 280 essentially continuously or periodically (e.g., every x number of minutes, every x number of seconds). In various embodiments, the End-of-Overload Detector 280 can decide that congestion no longer exists based upon a Control Channel Element (CCE) of a Physical Downlink Control Channel (PDCCH) that is not too high, a latency that is not too high, a throughput that is not too low, a signal quality that is not too low, a power level that is not too low, or any combination thereof.

Referring now to FIG. 2D, this is a diagram illustrating an example, non-limiting embodiment of data collection related to a traffic load management process (which can function fully or partially within the communication network of FIG. 1) in accordance with various aspects described herein. In this figure, the 5×5 grid represents binned geographic locations of various end user communication devices (in one specific example, each bin can be 10-meter x 10-meter and can be defined by latitude/longitude coordinates). In this example, an end user device in geographic bin 4-5 is shown as communicating with problem cell A2. Further, another end user device in geographic bin 4-5 is shown as communicating with cell A1. Of course, while only two end user devices are shown in the figure, any number of end user devices can be located in bin 4-5. Further, any number of cells can be utilized. In any case, as seen, the data from the coordinates of bin 4-5 is aggregated into Table 1 (again, any number of end user devices can be accommodated). Further still, in this example, data from a plurality of end user devices located in geographic bin 2-5 is aggregated into Table 2 (again, any number of end user devices can be accommodated). This data collection can be carried out (over a certain time span or period (e.g., number of days)) in each bin in which an end user device is located and is communicating with a problem cell (in one specific example, the grid can cover 10 miles×10 miles). Each RSRP value (e.g., signal level) and each RSRQ value (e.g., interference) can be reported, for example, by a respective end user device. As a result of the data collection, a number of tables such as shown in this figure can be produced. The binned data in the tables can then be utilized to control traffic loads as described, for example, in connection with FIG. 2E discussed below.

Referring now to FIG. 2E, this is a diagram illustrating an example, non-limiting embodiment of a data chart 290 related to a traffic load management process (which can function fully or partially within the communication network of FIG. 1) in accordance with various aspects described herein. As seen in this figure, data (e.g., for a problem cell that is experiencing congestion) can be formed into a histogram with RSRP and/or RSRQ segments along the x-axis and number of occurrences (e.g., from the tables of FIG. 2D) along the y-axis. So, in this example, for a given RSRP value the total number of records in all of the tables of FIG. 2D can be plotted as a single corresponding vertical segment. Similarly, for a given RSRQ value the total number of records in all of the tables of FIG. 2D can be plotted as a single corresponding vertical segment. In operation, an existing (or current) minimum threshold 290a can be known and then, based upon a desired number of users (or devices) to be dropped, a new minimum threshold 290b can be determined. In various embodiments, it may be desired to drop a certain percent of users/devices (e.g., 20%) and such desired percentage drop can be used in order to determine the new minimum threshold 290b. In various embodiments, the x-axis can plot different metrics, such as (for example) signal quality, signal-to-noise ratio, or any combination thereof. In various embodiments, a user/device being dropped can be dropped from the problem cell without specifying a replacement target cell to receive the dropped user/device. In various embodiments, an amount of traffic to be shifted can be decided from within a graphical user interface (GUI.). Of course, while the example in this FIG. 2E shows a 10 dB shift, the algorithm can produce any desired shift value.

Referring now to FIG. 2F, various steps of a method 2000 according to an embodiment are shown. As seen in this FIG. 2F, step 2002 comprises determining that a first network node device satisfies an overload threshold related to first network communication devices connected to the first network node device, resulting in a first determination. Next, step 2004 comprises identifying a second network node device that satisfies an availability threshold and that is initiating incoming handovers of second network communication devices, different than the first network communication devices, to the first network node device. Next, step 2006 comprises assigning one or more first values to one or more respective first relation parameters, each first value being associated with control of the incoming handovers of the second network communication devices. Next, step 2008 comprises selecting a third network node device that satisfies an availability threshold, the third network node device being selected to receive outgoing handovers from the first network node device. Next, step 2010 comprises assigning one or more second values to one or more respective second relation parameters, each second value being associated with control of the outgoing handovers to the third network node device, wherein the one or more second values are assigned independently of the one or more first values. Next, step 2012 comprises facilitating use of the one or more first values to control the incoming handovers of the second network communication devices. Next, step 2014 comprises facilitating use of the one or more second values to control the outgoing handovers from the first network node device.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2G, various steps of a method 2100 according to an embodiment are shown. As seen in this FIG. 2G, step 2102 comprises obtaining first data indicative of an existing cutoff value of a communication quality, wherein the first data is a parameter that is currently set in a network (see, e.g., current qRXLevMin 290a of FIG. 2E). Next, step 2104 comprises obtaining second data indicative of a plurality of current communication qualities, wherein each of the plurality of current communication qualities comprises Reference Signal Received Power (RSRP), Reference Signal Received Quality (RSRQ), or any combination thereof (see, e.g., values along the x-axis of FIG. 2E). Next, step 2106 comprises segmenting the second data such that each of the current communication qualities is placed into one of a plurality of segments, wherein each of the plurality of segments has a corresponding numerical count, resulting in a segmented data set (see, e.g., each vertical bar of FIG. 2E). Next, step 2108 comprises selecting a percentage of a total number of the current communication qualities to be subject to congestion control, wherein the selecting results in a selected percentage. Next, step 2110 comprises determining, based upon the segmented data set and the selected percentage, a modified cutoff value of the communication quality (see, e.g., new qRXLevMin 290b of FIG. 2E), wherein the modified cutoff value is a modification of the parameter that had been set in the network. Next, step 2112 comprises facilitating the congestion control based upon the modified cutoff value of the communication quality.

While for purposes of simplicity of explanation, the respective processes are shown and described as a series of blocks in FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2H, various steps of a method 2200 according to an embodiment are shown. As seen in this FIG. 2H, step 2202 comprises determining, by a processing system including a processor, whether a first carrier (or cell) within a sector of a communications network is cooperating with a second carrier (or cell) of the same sector in a carrier aggregation process that facilitates communications with a plurality of end user mobile devices, resulting in a first determination. Next, step 2204 comprises determining, by the processing system, that the first carrier (or cell) satisfies an overload threshold, resulting in a second determination. Next, step 2206 comprises responsive to the first determination being that the first carrier (or cell) is cooperating with the second carrier (or cell) in the carrier aggregation process and to the second determination being that the first carrier (or cell) satisfies the overload threshold, causing, by the processing system, the first carrier (or cell) to terminate the carrier aggregation process.

While for purposes of simplicity of explanation, the respective processes are shown and described as a series of blocks in FIG. 2H, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, various embodiments can be applied to facilitate (e.g., automatically facilitate) traffic load management.

As described herein, various embodiments can be applied to offload traffic from one or more congested cells.

As described herein, various embodiments can be applied in the context of traffic offload SON Automation on ONAP.

As described herein, various embodiments can be applied to offload traffic from one or more problem cells in order to restore service (which can reduce churn and/or reduce the need to increase cell capacity).

As described herein, various embodiments provide for CIO/qOffset padding in various frequency bands (e.g., LB, MB, HB, B14). The CIO/qOffset padding can be based upon a source cell's band and a target cell's band. The CIO/qOffset padding can be applied on top of any other required CIO for connected mode and qoffset for idle mode that is decided by a GUI. The CIO/qOffset padding can be applied to a problem cell (congested cell) toward outgoing cells. The CIO/qOffset padding can be used for incoming cells (towards problem cells) separately.

As described herein, various embodiments provide for traffic load balancing between co-face cells.

As described herein, various embodiments can determine an overload condition as an average (e.g., an average over a prior x number of monitoring periods).

As described herein, various embodiments can operate in the context of markets and/or sub-markets.

As described herein, various embodiments can operate on a periodic monitoring cycle (e.g., every 5 minutes, or every 10 minutes, or every 15 minutes, or every 20 minutes).

As described herein, various embodiments can select as a user-configurable maximum the number of outgoing cells to use.

As described herein, various embodiments can provide an ability to trigger on different trigger conditions for coverage restriction. For example, a user can select the throughput and resource utilization for coverage restriction at a different level than the overload condition triggers (hence, in this example, only cells with exceptionally low throughput will see coverage restriction making the solution more targeted).

As described herein, various embodiments can be applied in the context of 4th generation (4G) cellular systems, 5th generation (5G) cellular systems, and/or subsequent generation cellular systems.

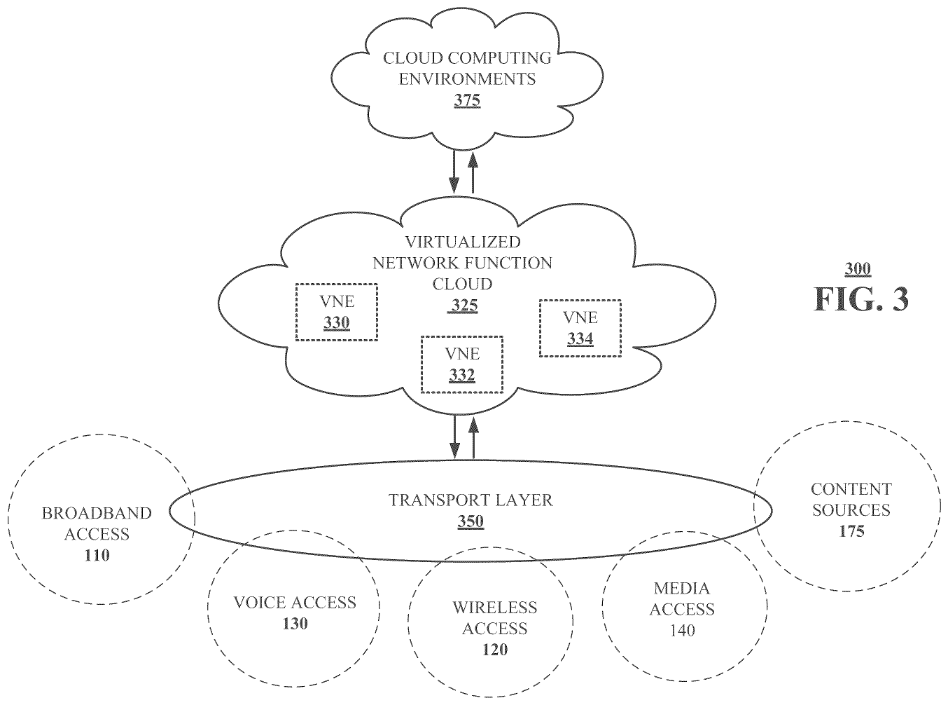

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, some or all of the subsystems and functions of system 200, some or all of the subsystems and functions of system 230, some or all of the subsystems and functions of system 270, some or all of the functions related to chart 290, and/or some or all of the functions of methods 2000, 2100, 2200. For example, virtualized communication network 300 can facilitate in whole or in part traffic load management for one or more wireless communication networks (e.g., traffic load management for an access point (or node) that is experiencing traffic congestion).

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

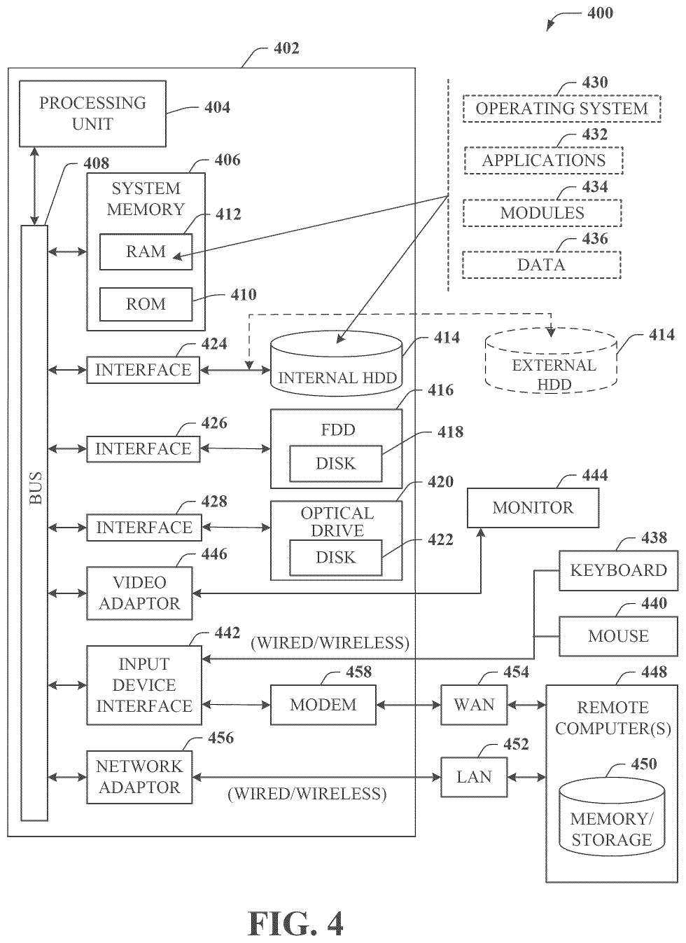

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part traffic load management for one or more wireless communication networks (e.g., traffic load management for an access point (or node) that is experiencing traffic congestion).

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

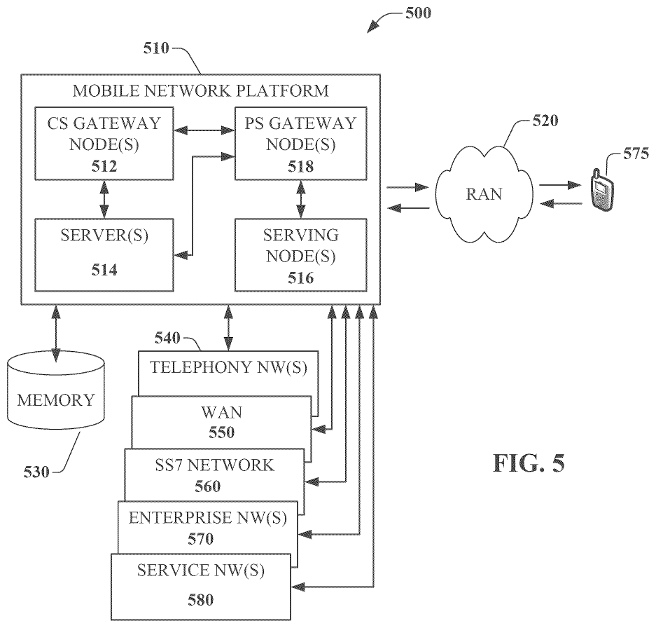

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part traffic load management for one or more wireless communication networks (e.g., traffic load management for an access point (or node) that is experiencing traffic congestion). In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

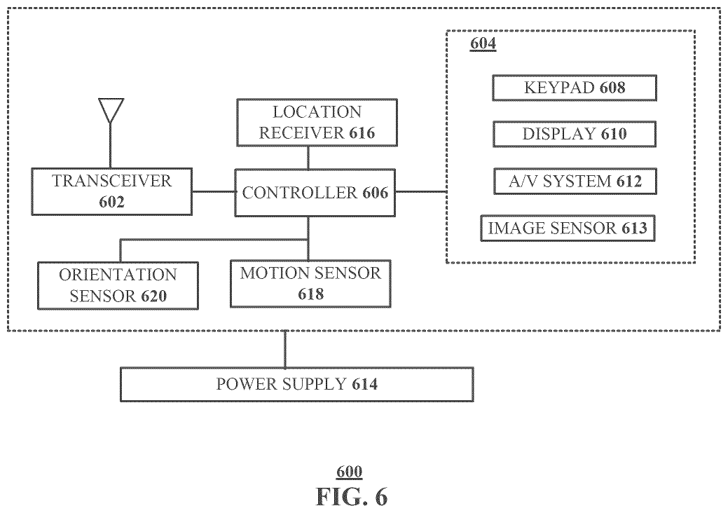

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part traffic load management for one or more wireless communication networks (e.g., traffic load management for an access point (or node) that is experiencing traffic congestion).

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1×, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically facilitating traffic load management for one or more wireless communication networks) can employ various AI-based schemes for carrying out various embodiments thereof. Moreover, the classifier can be employed to determine a ranking or priority of each access point, node, end user device, and/or network resource. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the access point(s), node(s), end user device(s), and/or network resource(s) is to receive priority.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
determining that a first network node device satisfies an overload threshold related to first network communication devices connected to the first network node device, resulting in a first determination;
identifying a second network node device that satisfies an availability threshold and that is initiating incoming handovers of second network communication devices, different than the first network communication devices, to the first network node device;
assigning one or more first values to one or more respective first relation parameters, each first value being associated with control of the incoming handovers of the second network communication devices;
selecting a third network node device that satisfies an availability threshold, the third network node device being selected to receive outgoing handovers from the first network node device;
assigning one or more second values to one or more respective second relation parameters, each second value being associated with control of the outgoing handovers to the third network node device, wherein the one or more second values are assigned independently of the one or more first values;
facilitating use of the one or more first values to control the incoming handovers of the second network communication devices; and
facilitating use of the one or more second values to control the outgoing handovers from the first network node device.

2. The device of claim 1, wherein:
the device is part of the first network node device;
the first network node device comprises a first cell;
the second network node device comprises a second cell;
the third network node device comprises a third cell; and
each relation parameter comprises a respective cell individual offset (CIO) for Connected mode, a respective qOffset for Idle mode, a respective cell relation parameter, a respective cell parameter, a respective frequency relation parameter, or a respective combination thereof.

3. The device of claim 1, wherein the first network node device satisfying the overload threshold comprises:
a PDCCH control channel element (CCE) utilization associated with the first network communication devices connected to the first network node device satisfying a PDCCH CCE threshold;
a throughput associated with the first network communication devices connected to the first network node device satisfying a throughput threshold; or
any combination thereof.

4. The device of claim 3, wherein:
the PDCCH CCE utilization comprises an aggregate PDCCH CCE utilization associated with the first network communication devices; and
the PDCCH CCE utilization satisfying the PDCCH CCE threshold comprises the CCE utilization exceeding the PDCCH CCE threshold.

5. The device of claim 3, wherein:
the throughput comprises an aggregate throughput associated with the first network communication devices; and
the satisfying the throughput threshold comprises the throughput being below the throughput threshold.

6. The device of claim 1, wherein:
the one or more first relation parameters comprise for the second network node a first cell individual offset (CIO) for Connected mode, a first qOffset for Idle mode, a first cell parameter, a first cell relation parameter, a first frequency relation parameter, or a combination thereof; and
the one or more second relation parameters comprise for the third network node a second cell individual offset (CIO) for Connected mode, a second qOffset for Idle mode, a second cell relation parameter, a second frequency relation parameter, or a combination thereof.

7. The device of claim 1, wherein the facilitating the use of the one or more first values to control the incoming handovers of the second network communication devices comprises:
utilizing the one or more first values by the second network node device.

8. The device of claim 1, wherein the facilitating the use of the one or more second values to control the outgoing handovers from the first network node device comprises:
utilizing the one or more second values by the first network node device.

9. The device of claim 1, wherein each of the first network communication devices and the second network communication devices comprises a respective one of: a smartphone, a cellphone, a mobile communication device, a desktop computer, a laptop computer, a notebook computer, a tablet computer, or any combination thereof.

10. The device of claim 9, wherein the outgoing handovers from the first network node device are associated with a subset of the first network communication devices.

11. The device of claim 1, wherein each of the first network node device, the second network node device, and the third network node device comprises a respective one of: a base station, a cell site, an eNodeB, a gNodeB, a 4th generation (4G) access point, a 5th generation (5G) access point, a subsequent generation access point, or any combination thereof.

12. The device of claim 1, wherein the facilitating the use of the one or more first values to control the incoming handovers of the second network communication devices and the facilitating the use of the one or more second values to control the outgoing handovers from the first network node device are responsive to the first determination being that the first network node device satisfies the overload threshold related to first network communication devices connected to the first network node device.

13. The device of claim 1, wherein the operations further comprise determining that the first network node device no longer satisfies the overload threshold, resulting in a second determination.

14. The device of claim 13, wherein responsive to the second determination being that the first network node device satisfies an end of overload condition, the operations further comprise:
reverting the one or more first values to one or more prior first values that were utilized prior to the assigning of the one or more first values;
reverting the one or more second values to one or more prior second values that were utilized prior to the assigning of the one or more second values.

15. The device of claim 14, wherein responsive to the second determination being that the first network node device satisfies the end of overload condition, the operations further comprise:
utilizing the one or more prior first values by the second network node device; and
utilizing the one or more prior second values by the first network node device.

16. A non-transitory machine-readable medium comprising executable instructions that, when executed by a processing system including a processor, facilitate performance of operations, the operations comprising:
obtaining first data indicative of an existing cutoff value of a communication quality, wherein the first data is a parameter that is currently set in a network;
obtaining second data indicative of a plurality of current communication qualities, wherein each of the plurality of current communication qualities comprises Reference Signal Received Power (RSRP), Reference Signal Received Quality (RSRQ), or any combination thereof;
segmenting the second data such that each of the current communication qualities is placed into one of a plurality of segments, wherein each of the plurality of segments has a corresponding numerical count, resulting in a segmented data set;
selecting a percentage of a total number of the current communication qualities to be subject to congestion control, wherein the selecting results in a selected percentage;
determining, based upon the segmented data set and the selected percentage, a modified cutoff value of the communication quality, wherein the modified cutoff value is a modification of the parameter that had been set in the network; and
facilitating the congestion control based upon the modified cutoff value of the communication quality.

17. The non-transitory machine-readable medium of claim 16, wherein:
the first data is obtained from the network;
the network is a wireless cellular network;
the second data is obtained from a plurality of different geographic locations;
the segmented data set is in a form of a histogram; and
the selected percentage is a non-zero percentage.

18. The non-transitory machine-readable medium of claim 16, wherein:
each RSRP value and each RSRQ value is associated with one of a plurality of end user mobile devices; and
the congestion control comprises terminating communications with one or more of the plurality of end user mobile devices.

19. A method, comprising:
determining, by a processing system including a processor, whether a first carrier within a sector of a communications network is cooperating with a second carrier of the same sector in a carrier aggregation process that facilitates communications with a plurality of end user mobile devices, resulting in a first determination;
determining, by the processing system, that the first carrier satisfies an overload threshold, resulting in a second determination; and
responsive to the first determination being that the first carrier is cooperating with the second carrier in the carrier aggregation process and to the second determination being that the first carrier satisfies the overload threshold, causing, by the processing system, the first carrier to terminate the carrier aggregation process.

20. The method of claim 19, wherein:
the sector is in a eNodeB or a gNodeB;
each of the plurality of end user mobile devices comprises a respective one of: a smartphone, a cellphone, a mobile communication device, a laptop computer, a notebook computer, a tablet computer, or any combination thereof;
the overload threshold comprises:
a PDCCH control channel element (CCE) utilization exceeding a PDCCH CCE threshold of the first carrier;
a throughput associated with the first carrier being below a throughput threshold;
a latency associated with the first carrier being above a latency threshold; or
any combination thereof; and
the causing of the first carrier to terminate the carrier aggregation process results in improved communications for one or more end user mobile devices that remains communicating with the first carrier.
